(19) United States
(12) Patent Application Publication
(10) Pub. No.: US 2015/0042191 A1
(43) Pub. Date: Feb. 12, 2015

(54) Brake Caliper Magnet Energy Generating Apparatus

(71) Applicant: Christopher Robinett, Powder River, WY (US)

(72) Inventor: Christopher Robinett, Powder River, WY (US)

(21) Appl. No.: 13/962,845

(22) Filed: Aug. 8, 2013

(51) Int. Cl. H02K 7/106

(52) U.S. Cl. CPC H02K 7/106
USPC 310/77

(57) ABSTRACT

This invention generates electric power from the rotational motion of the braking system of wheeled vehicle having brake rotors. As the brake rotor, comprised of conducting surface regions and non-conducting surface regions rotates, a magnet, which is disposed in close proximity to the brake rotor's conducting and non-conducting surface regions, generates an electric current to provide electric energy to a energy supply device, typically a battery.

### FIELD OF THE INVENTION

The invention pertains to the field of generating electric power from the rotational motion of the braking system of wheeled vehicle having brake rotors.

### BACKGROUND OF THE INVENTION

Many people consider electric cars to be the future of transportation. As petroleum globally continues to be depleted and various regulations, which disfavor the use of petroleum and gas fuel, the gas combustion engine is slowly being phased out in favor of electric cars. Despite the many advantages of electric cars, current complaints of electric include the relative short distance required to travel before the electric storage device, or battery, must be recharged. For this reason the transition to electric automobiles continues to be rather sluggish.

Gas engine powered vehicles are generally able to travel farther distances than their electric counterparts due to the energy density of gasoline relative to the energy density of electric vehicle batteries. While current developments in electric vehicle battery technology obtain greater and greater travel distances, there remains more that can be done to facilitate up the efficiency of electric vehicles to increase the distances they can travel before a recharge is required.

Currently, a moving vehicle creates significant energy that is wasted. In order to increase the efficiency of electric cars and, it is important to harvest the wasted energy and if possible convert it into usable energy

It would be highly advantageous to find a means to recharge the battery of a vehicle through converting wasted energy into usable energy. Locating various wasted energy sources and strategically applying scientific and engineering principles to increase energy efficiency benefits vehicle manufacturers in that they are able to offer more efficient vehicles. Vehicle consumers and users benefit from harvesting currently wasted energy as their cost of operation is significantly less. Harvesting currently wasted energy, which is generally dissipated or unused, can be used to at least partially recharge vehicle energy storage devices or batteries. Innovation which increases the distances electric vehicles travel, via use of energy currently wasted, would have significant benefits. Thus, there is a long felt need for innovation to increase energy sources and enhance the operational efficiency of vehicles.

### SUMMARY OF THE INVENTION

Accordingly, it is an object of embodiments of the present invention to provide an invention which relates an apparatus that generates electric power to provide a means to charge and re-charge electric energy storage devices or batteries during the motion of a vehicle having a brake rotor.

The present invention is concerned with a new and novel use of at least one magnet in close proximity to a brake rotor having surface regions comprised of conducting and non-conducting materials. To achieve the foregoing and other objects, and in accordance with the purposes of the present invention, as embodied and broadly described herein, the invention comprises an apparatus to generate electric power comprising an at least one magnet secured to brake caliper and disposed in close proximity to a brake rotor having a brake rotor top planar surface, a brake rotor bottom planar surface and an brake rotor outer edge therebetween and the at least one magnet in contact with a electric conducting wire further in contact with energy storage device that is able to convert alternating electric current to electric energy. As the brake rotor, having conducting material surface regions and non-conducting material surface regions, rotates, the at least one magnet in close proximity to the brake rotor generates alternating electric current.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

Benefits and advantages of the present invention include, but are not limited to, providing a apparatus, which provides a means to generate electric energy from a brake rotor's rotation which would otherwise be lost and unused. The invention is provides an easy way to effectuate the harvest of currently lost energy during brake rotor rotation.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a side planar view of one embodiment of the present invention wherein magnets are mounted to the brake caliper and are in close proximity to the top surface of the brake rotor.

FIG. 2 illustrates a side planar view of the embodiment shown in FIG. 1 as the brake rotor rotates and electric current is generated.

FIG. 3 illustrates a side planar view of another embodiment of the present invention wherein the magnet is in close proximity to the outer edge of a brake rotor.

FIG. 4 illustrates a top planar view of one embodiment of the embodiment shown in FIG. 3.

FIG. 5 illustrates a top planar view of the embodiment of the present invention shown in FIG. 3 and FIG. 4 wherein the brake rotor rotates and a current is generated via the magnet in close proximity to the edge of the brake rotor.

### DETAILED DESCRIPTION OF THE INVENTION

Reference will now be made in detail to embodiments of the invention, examples of which are illustrated in the accompanying drawings. Throughout the following detailed description, the same reference characters refer to the same or similar elements in all figures.

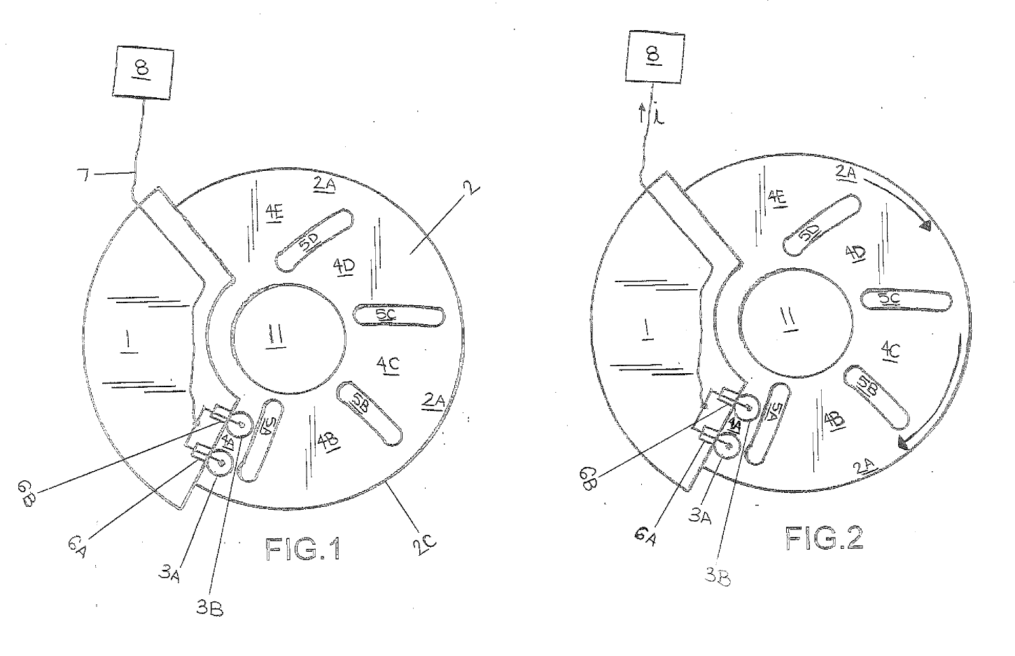

FIG. 1 depicts one embodiment of the present invention wherein a brake caliper 1 has two magnets, 3A and 3B secured to it via mounting brackets, 6A and 6B, respectively. The braking system of many vehicles includes a brake rotor 2 having a top planar brake rotor surface 2A, a bottom planar brake rotor surface 2B, not depicted in FIG. 1, and an outer brake rotor edge 2C between the top and bottom brake rotor plantar surfaces. In FIG. 1, the brake rotor 2 comprises a brake rotor top planar surface 2A comprised of surface regions, conducting material surface regions 4A, 4B, 4C, and 4D, and a non-conducting material surface regions 5A, 5B, 5C and 5D.

The magnets 3A and 3B are disposed in close positional proximity to the brake rotor 2. In some embodiments the term “close positional proximity” is a distance less than a millimeter from the brake rotor 2, and in other embodiments the distance is more than a centimeter. The magnets 3A and 3B in FIG. 1 and FIG. 2 are normal to and above the plane of the brake rotor top planar surface 2A of the brake rotor 2.

FIG. 1 depicts a conducting wire 7 in contact with the magnets 3A and 3B. The conducting wire creates electric contact between the energy storage device 8, typically a battery, and the magnets 3A and 3B. The axle hole 11 is disposed in the center of the brake rotor 2.

FIG. 2 depicts the brake rotor 2 in a clockwise rotation about the axel hole 11. The clockwise rotation is shown by the darkened curved arrows. As the brake rotor rotates, the magnets 3A and 3B are alternately exposed to the conducting material surface region 4A, then non-conducting material surface region 5A, then the conducting material surface region 4B, then non-conducting material surface region 5B, then conducting material surface region 4C, then non-conducting material surface region 5C, then conducting material surface region 4D, then non-conducting material surface region 5D, etc. As a result of the rotation of the brake rotor 2, the magnets 3A and 3B are exposed to and brought into proximity to alternating conducting material surface regions and non-conducting material surface regions, which results in the magnets 3A and 3B generating an alternating current. The alternating current, represented with an “i” and a smaller arrow, flows from the magnets through the conducting wire 7 to the energy storage device 8. The energy storage device converts the alternating current to stored energy.

While FIG. 1 and FIG. 2 depict four magnets, the invention, as contemplated herein, comprises in some embodiments as few as one magnet mounted to a brake caliper 1. The invention, according to other embodiments also contemplates a multiplicity, more than one magnet attached to a brake caliper. The term “at least one magnet” is meant to convey that one or more magnets are described and claimed in this invention, which seeks to harvest energy from magnet exposure to alternating non-conducting and conducting surface regions of a brake rotor.

The optimal amount of electric current production from the magnets is dependent upon the configuration of conducting and non-conducting surface regions and magnets distance from the regions of non-conducting surface material and conducting surface material. The optimal amount of electric current production from the magnets is also dependent upon the distance between the magnet and the surface of the rotor. The less distance between the magnet and the rotor surface, the more current will be produced upon brake rotor rotation. In some embodiments the distance is less than a millimeter, and in other embodiment the distance is more than a centimeter. The term “disposed in close proximity” contemplates a predetermined distance that optimizes energy production via the magnets close proximity to the rotatable surface of the brake rotor, yet also maintains magnet integrity, such that the magnet is not disposed in so close in positional proximity that the magnet has physical contact with any portion of brake rotor.

The invention further contemplates embodiments wherein the portion of the caliper that contacts the brake rotor bottom planar surface 2B during braking operations has at least one magnet attached to the caliper and would function in a similar manner to FIG. 1 and FIG. 2 depictions of the brake rotor top planar surface. Pursuant to this invention, it is further contemplated that embodiments of the invention comprise a brake rotor having both a brake rotor top planar surface in close proximity to at least one magnet and a brake rotor bottom planar surface in close proximity to at least one magnet.

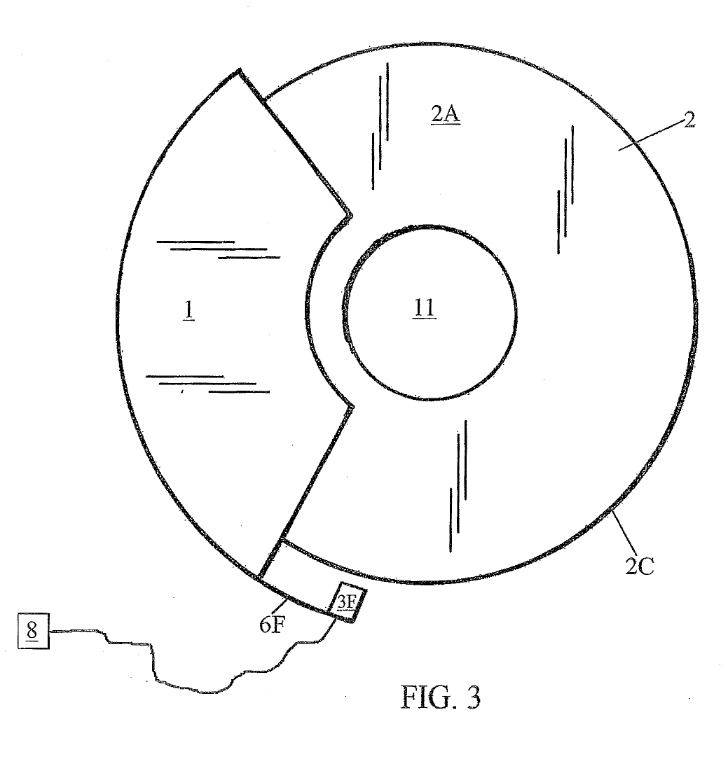

FIG. 3 depicts another embodiment of the present invention wherein the magnet 3F is in close proximity to the brake rotor outer edge 2C located between the top surface of the brake rotor top planar surface 2A and the brake rotor bottom planar surface 2B (not shown). In this embodiment, as shown in FIG. 3, the magnet 3F is attached to the brake caliper 1 by a mounting bracket 6F. The magnet 3F is in contact with the conducting wire 7, which is in electric contact with the energy storage device 8. The magnet 3F is in close positional proximity to the brake rotor 2B. The same principles of electric current production apply to this embodiment as the previous embodiment, as depicted in FIGS. 1 and 2, namely the closer the magnet is disposed to the brake rotor outer edge surface 2C the more current will be produced when the brake rotor rotates.

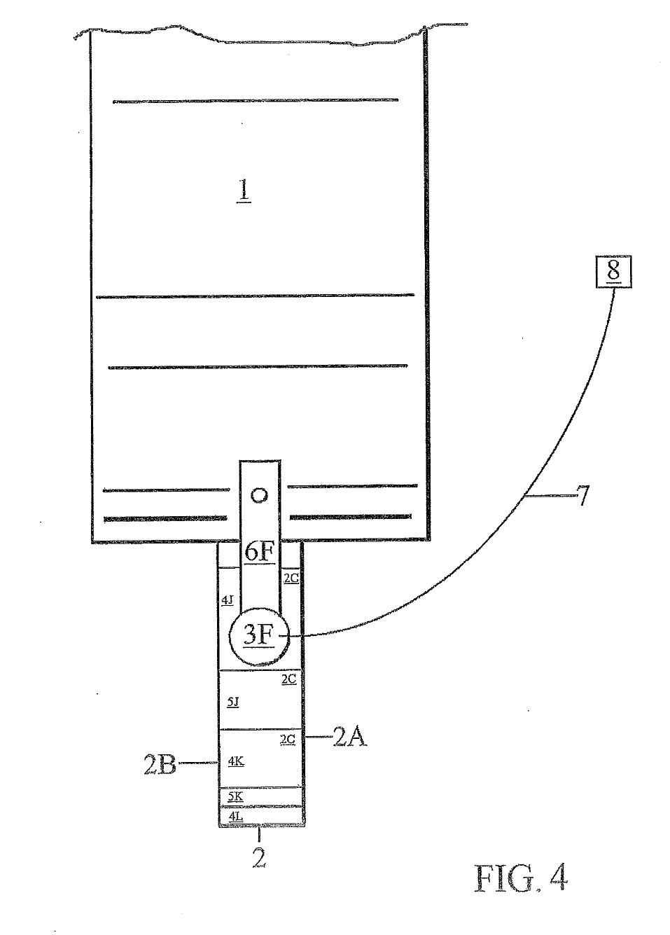

FIG. 4, a top planar view of the embodiment of the invention shown in FIG. 3, further depicts the brake caliper 1, secured to the mounting bracket 6F to the magnet 3F. The magnet 3F is in contact with a conducting wire 7, which makes electric contact between the energy storage device 8 and the magnet 3F.

FIG. 4 depicts the brake rotor to having a brake rotor top surface 2A, a brake rotor bottom surface 2B and a brake rotor edge 2C therebetween that defines the outer circumference of the brake rotor 2. Some a brake rotor edge surfaces will comprise alternating regions of conducting material and non-conducting material. In this depiction of one embodiment of the present invention, the brake rotor edge 2C is comprised of conducting material surface regions, including 4J, 4K and 4L, and non-conducting material surface regions, including 5J and 5K. FIG. 4 does not depict all regions of conducting material and regions of non-conducting material of the brake rotor edge. It is contemplated within the embodiments of this invention that the brake rotor edge 10 has alternating regions of conducting and non-conducting regions over its entire circumferential surface.

In the embodiment depicted in FIG. 4, the magnet 3F is disposed in close proximity to the rotor edge 2C of the brake rotor 2 but not touching the brake rotor at any point. FIG. 4B also shows the mounting bracket 6F attaching the magnet 3F to the brake caliper 1. FIG. 4 also shows conducting wire 7 in contact with the magnet 3F. The conducting wire 7 creates electric contact between the magnet 3F and the energy storage device 8.

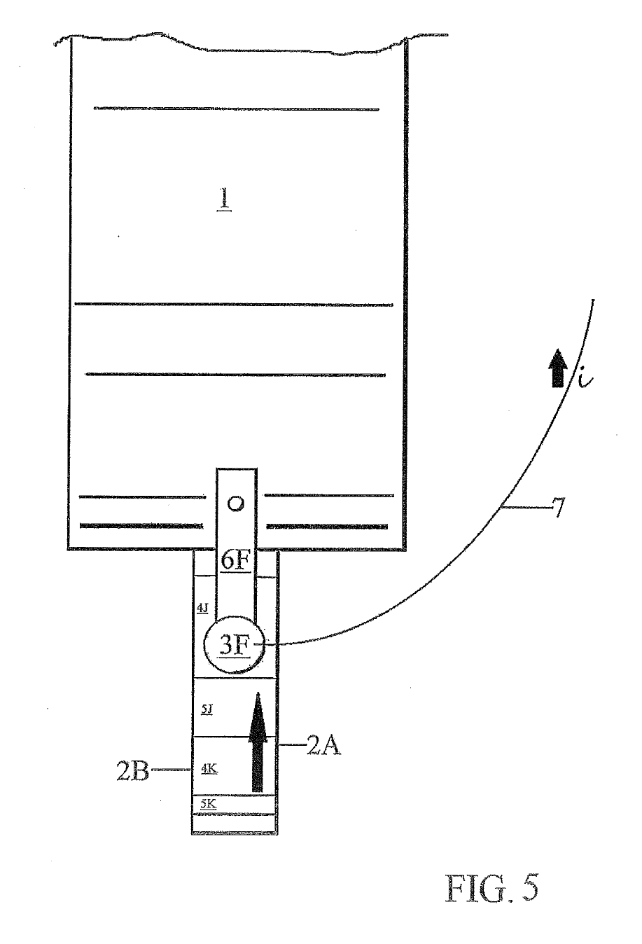

FIG. 5 depicts the brake rotor 2 rotating, as depicted by the darkened horizontal arrow. In the depicted top planar view of FIG. 5, the brake rotor rotation appears to be linear motion because the view is tangential to the curved rotor edge 2C. The magnet 3F is in close proximity to the rotor edge 2C and its conducting material surface regions and non-conducting material surface regions. As the brake rotor rotates, the magnet 3F is alternately exposed to the rotor edge 2C conducting material surface regions 4J, then the non-conducting material surface region 5J, then the conducting material surface region 4K, then the non-conducting material surface region 5K, then the conducting material surface region 4L, etc.

As a result of rotation of the brake rotor edge 2C, the magnet 3F is exposed to conducting material surface regions and non-conducting surface regions, which causes the magnet 3F to generate an alternating current. In FIG. 5, the alternating current, represented with an “i” and a smaller arrow, travels from the magnet 3F through the conducting wire 7 to the energy storage device 8. The energy storage device converts the alternating current to stored energy for later or contemporaneous use by the vehicle during other operations.

Typically, brake rotors are composed of regions of conducting material with interspersed regions of air space. The air space functions to dissipate heat generated by contact between the rotor and caliper during braking operations. In the embodiments of the invention, the brake rotor comprises conducting materials meant to include such material as steel, metals, metal alloy materials as are commonly known and used in brake rotors. Also, the brake rotor as manufactured comprise non-conducting materials such as air space, ceramics, carbon-based materials and insulator-based materials as are commonly known and comprise brake rotors.

It is further contemplated, with respect to this invention that there are embodiments comprising a brake rotor having at least one magnet in close proximity to the brake rotor top planar surface, at least one magnet in close proximity to the brake rotor bottom planar surface and at least one magnet in close proximity to the brake rotor outer edge.

In embodiments of the instant invention it is understood that the alternating current generated by the rotation of the brake rotor in close proximity to at least one magnet will be converted into energy in the energy storage device for use in the vehicle. Such conversion of alternating current into energy is well known in the electrical energy conversion arts.

It is also to be understood within the context of this invention that the means to secure magnet to either a brake caliper to bracket is well known in the attachment arts. Such methods include, but are not limited to screw(s), pin(s), epoxy(ies), adhesive(s), amongst the many methods known in the art of attachment, all of which are incorporated and contemplated herein.

It is believed that the apparatus of the present invention and many of its attendant advantages will be understood from the foregoing description. It is also believed that it will be apparent that various changes may be made in the form, construction, and arrangement of the components without departing from the scope and spirit of the invention and without sacrificing its material advantages. The forms described are merely exemplary and explanatory embodiments thereof. It is the intention of the following claims to encompass and include such changes.

What we claim is:

1. An apparatus to generate electric energy comprising at least one magnet secured to a brake caliper and disposed in close proximity to a brake rotor comprising a brake rotor top planar surface, a brake rotor bottom planar surface and a brake rotor outer edge therebetween and said at least one magnet in contact with a conducting wire in contact with an energy storage device.

2. The apparatus of claim 1, wherein said brake rotor top planar surface comprises at least one conducting material surface region and at least one non-conducting material surface region.

3. The apparatus of claim 2, wherein the at least one conducting material surface region is comprised of any of the following: metal, steal, and metallic alloy.

4. The apparatus of claim 2, wherein the at least one non-conducting material surface region is comprised of any of the following: air space, ceramics, carbon-based materials and insulator-based materials.

5. The apparatus of claim 1, wherein a bracket secures said brake caliper to said at least one magnet.

6. The apparatus of claim 2, wherein said at least one magnet is disposed a predetermined distance from the brake rotor top planar brake surface such that as the brake rotor rotates an electric current is generated.

7. The apparatus of claim 1, wherein said brake rotor bottom surface comprises at least one conducting material surface region and at least one non-conducting material surface region.

8. The apparatus of claim 7, wherein the at least one conducting material surface region is comprised of any of the following: metal, steal, and metallic alloy.

9. The apparatus of claim 7, wherein the at least one non-conducting material surface region is comprised of any of the following: air space, ceramics, carbon-based materials and insulator-based materials.

10. The apparatus of claim 7, wherein said at least one magnet is disposed a predetermined distance from the brake rotor bottom brake surface such that as the rotor rotates an electric current is generated.

11. The apparatus of claim 1, wherein said brake rotor outer edge is comprised of at least one conducting material surface region and at least one non-conducting material surface region.

12. The apparatus of claim 11, wherein the at least one conducting material is comprised of any of the following: metal, steal, and metallic alloy.

13. The apparatus of claim 7, wherein the at least one non-conducting material is any of the following: air space, ceramics, carbon-based materials and insulator-based materials.

14. The apparatus of claim 7, wherein said magnet is disposed a predetermined distance from the brake rotor top planar brake surface such that as the rotor rotates an electric current is generated.
